(19) United States
(12) Patent Application Publication
(10) Pub. No.: US 2025/0158315 A1
(43) Pub. Date: May 15, 2025

(54) Connecting Terminal

(71) Applicant: Tyco Electronics (Shanghai) Co., Ltd., Shanghai (CN)

(72) Inventors: Yang (Leon) Zou, Shanghai (CN); Liming (Eric) Wang, Shanghai (CN); Xinxin (Daisy) Li, Shanghai (CN); Zebin (Donnie) Tang, Shanghai (CN); Feng (Will) Chen, Shanghai (CN)

(73) Assignee: Tyco Electronics (Shanghai) Co., Ltd., Shanghai (CN)

(21) Appl. No.: 18/946,482

(22) Filed: Nov. 13, 2024

(30) Foreign Application Priority Data
Nov. 13, 2023 (CN) 202311507608.9

(51) Int. Cl. H01R 13/504; H01R 13/527

(52) U.S. Cl. CPC H01R 13/504; H01R 13/527

(57) ABSTRACT

A connecting terminal includes a conductor member and a housing. The conductor member is at least partially enclosed by the housing. The housing includes a first body made of a first resin material and a second body made of a second resin material. The first resin material is different from the second resin material. The first body and the second body are integrated.

### CROSS-REFERENCE TO RELATED APPLICATION

This application claims the benefit of the filing date under 35 U.S.C. § 119 (a)-(d) of Chinese Patent Application No. 202311507608.9, filed on Nov. 13, 2023.

### FIELD OF THE INVENTION

The present invention relates to an electrical connection, and more particularly, to a connecting terminal.

### BACKGROUND

Pre-insulated quick-connecting terminals (Ultra-Fast) are a type of cold-pressed terminals. A pre-insulated quick-connecting terminal is connected to a cable and to a mating connector respectively, thus enabling electrical transmission between them. The quick-connecting terminal includes a metal member and an insulating housing made of a single resin material. The resin material has a certain degree of transparency in order to allow a user to view the connection condition of the metal member and the cable in the resin material. In addition, during the use of the terminal, plastic deformation may happen in the housing, so the resin material needs to have a high degree of toughness to prevent the housing from cracking during use. Consequently, the range of such resin materials to choose from is very limited. The housing made of the single resin material is more costly and has unsatisfactory performance in other respects (e.g., flame retardance).

### SUMMARY

A connecting terminal includes a conductor member and a housing. The conductor member is at least partially enclosed by the housing. The housing includes a first body made of a first resin material and a second body made of a second resin material. The first resin material is different from the second resin material. The first body and the second body are integrated.

### BRIEF DESCRIPTION OF THE DRAWINGS

The invention will now be described by way of example with reference to the accompanying figures, of which:

FIG. 1 is a perspective view of a connecting terminal according to an embodiment;

FIG. 2 is another perspective view of the connecting terminal of FIG. 1;

FIG. 3 is a perspective view of a first body and a second body of the connecting terminal of FIG. 1 before they are all integrated;

FIG. 4 is a perspective view showing a connecting terminal according to another embodiment;

FIG. 5 is another perspective view of the connecting terminal of FIG. 4;

FIG. 6 is a perspective view of a first body and a second body of the connecting terminal of FIG. 4 before they are integrated;

FIG. 7 is a perspective view of a connecting terminal according to another embodiment;

FIG. 8 is another perspective view of the connecting terminal of FIG. 7;

FIG. 9 is a perspective view of a first body and a second body of the connecting terminal of FIG. 7 before they are integrated;

FIG. 10 is a perspective view showing a connecting terminal according to another embodiment;

FIG. 11 is another perspective view of the connecting terminal of FIG. 10; and

FIG. 12 is a perspective view a first body and a second body of the connecting terminal of FIG. 10 before they are integrated.

### DETAILED DESCRIPTION OF THE EMBODIMENTS

In the following detailed description of the embodiments, reference will be made to the accompanying drawings which form part of the present disclosure. The accompanying drawings show, by way of example, particular embodiments capable of implementing the present disclosure. The exemplary embodiments are not intended to be exhaustive of all embodiments according to the present disclosure. In the specification, the same or similar reference signs indicate the same or similar components. It will be appreciated that other examples may be utilized, and structural modifications may be made without departing from the scope of the present disclosure. Accordingly, the following detailed description is not limiting and the scope on the present disclosure is defined by the appended claims.

Throughout the specification the terms “including,” “comprising” and similar terms used herein should be understood as open-ended terms, i.e., “including/comprising but not limited to,” indicating that other elements may also be included. Additionally, terms such as upper, lower, etc., are used in describing individual components. However, the meaning of such terms are relative meaning they are appropriate when the components are arranged as shown in the drawings, but when the position of the components in the drawings changes, such terms may change accordingly.

The implementations and use of embodiments are discussed in detail below. It should be understood, however, that the specific embodiments discussed are merely exemplary of particular ways of implementing and using the present disclosure and are not intended to limit the scope of the present disclosure.

A connecting terminal 10 according to an embodiment is shown in FIGS. 1-3.

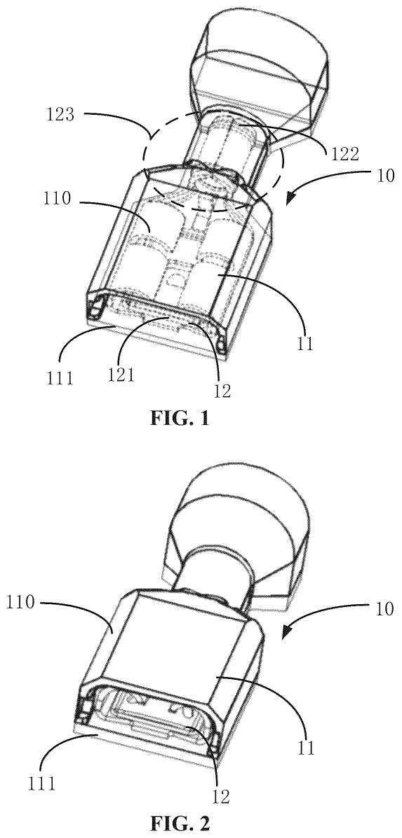

As shown in FIGS. 1-2, the connecting terminal 10 comprises a housing 11 and a conductor member 12. The housing 11 at least partially encloses the conductor member 12. In an embodiment, the conductor member 12 is made of a metal material. The housing 11 comprises a first body 110 and a second body 111. The first body 110 and the second body 111 are integrally formed. The first body 110 is made of a first resin material and the second body 111 is made of a second resin material.

The conductor member 12 of the connecting terminal 10 includes a first end 121 and a second end 122. The first end 121 of the conductor member 12 electrically connects to the mating connector by, for example, plugging to the mating connector. The second end 122 of the conductor member 12 has a shape that is a circular aperture shape. After removing the insulating layer of a cable, an exposed metal core is crimped and enters the circular aperture of the second end 122, which enables the metal core of the cable to be electrically connected to the second end 122 of the conductor member 12.

As shown in FIG. 1, the first body 110 in an embodiment is made of the first resin material that is made of a transparent material or a translucent material as described in more detail below. As shown in FIG. 1, the first body 110 is adjacent to a connection part 123 of the conductor member 12 to enable the user to be able to view, through the first body 110, the connection condition of the conductor member 12, for example, whether the cable is inserted in place, and whether the second end 122 of the conductor member 12 is well connected to the cable. In various other embodiments, the connection part 123 of the conductor member 12 may be used to connect the connecting terminal 10 with another connector.

The first resin material of the first body 110 is different from the second resin material of the second body 111. The first resin material, in an embodiment, is a transparent material or a translucent material, so that the user can view at least a portion of the conductor member 12 through the first body 110. Thus, the first resin material has certain transparency properties to meet the visualization need for a connection part of the terminal. In an embodiment, the second resin material has a higher toughness than the first resin material to avoid cracks in the housing 11 of the connecting terminal 10 during use. In an embodiment, the second resin material may be an opaque material.

The first resin material in an embodiment may be a first polycarbonate material having high transparency. In various embodiments the first resin material is polycarbonate (PC) or any like material(s) that allow the first body 110 to function as described herein. The second resin material in an embodiment may be a transparent or opaque second polycarbonate material. In various embodiments the second resin material may be polycarbonate/acrylonitrile-butadiene-styrene copolymer (PC/ABS), polycarbonate/polyethylene terephthalate copolymer (PC/PET), or any other like material(s) that allow(s) the second body 111 to function as described herein. In various other embodiments the first resin material may be a first polyamide material having high transparency, such as polyamide (PA) or any like material that allows the first body 110 to function as described herein; and the second resin material may be a transparent or opaque second polyamide material such as polyamide 6 (PA6), polyamide 66 (PA66), polyamide 66/6 (PA66/6), or any other like material that allows the second body 111 to function as described herein.

In another embodiment of the connecting terminal 10, the housing 11 may further comprise a third body, which is integrally formed with the first body 110 and the second body 111. The third body may be located at any suitable position of the housing 11.

In an embodiment, the third body may be made of a colored third polycarbonate material, which is different from the first polycarbonate material of the first body 110 or the second polycarbonate material of the second body 111. In various embodiments, the third polycarbonate material may be a polycarbonate (PC) based resin in colors such as red, yellow, blue, or any like material having any color that allows the third polycarbonate material to function as described herein. The various embodiments of the third polycarbonate material would have a color as described above in order to identify or distinguish the connecting terminal 10.

In another embodiment, the third body may be made of a colored third polyamide material, which is different from the first polyamide material of the first body 110 or the second polyamide material of the second body 111. In various embodiments, the third polyamide material may be a polyamide (PA) based resin in colors such as red, yellow, blue, or any like material having any color that allows the third body to function as described herein. The various embodiments of the third polyamide material would have a color as described above in order to identify or distinguish the connecting terminal 10.

A first way of forming the housing 11 of the connecting terminal 10 using secondary injection molding is now described.

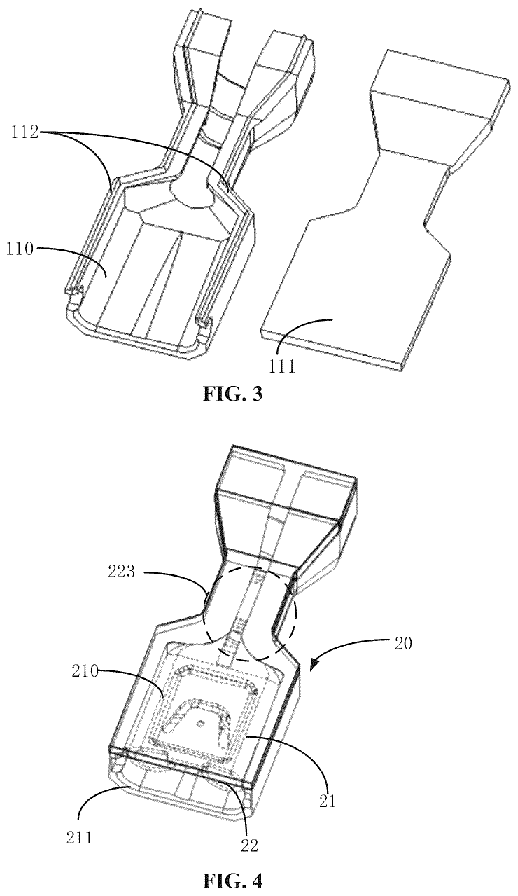

For example, the first resin material and the second resin material may form the housing 11 by secondary injection molding. The first resin material may be injected into a first set of molds and cooled to be molded as the first body 110 as shown in FIG. 3. The internal structure of the first set of molds may make the first body 110 as molded have a convex rib 112. Subsequently, the first body 110 may be placed into a second set of molds in which the second resin material is then injected. The second body 111 and the first body 110 may be fused together as a single body after a heat fusion stage. Finally, the housing 11 as molded may be obtained by cooling and demolding. Due to the presence of the convex rib 112 in the first body 110 before the heat fusion, a concave-convex structured bond part would be formed between the first body 110 and the second body 111 after the heat fusion, which increases the heat fusion bonding area between the first body 110 and the second body 111, thereby improving the bonding force between the first resin material and the second resin material. Thus, the first body 110 and the second body 111 are bonded to each other at the convex rib 112.

Another way of forming the housing 11 of the connecting terminal 10 using two-color injection molding is now described.

For example, the first resin material and the second resin material may form the housing 11 by two-color injection molding. The first resin material and the second resin material may be injected into a mold simultaneously or sequentially using a two-color injection molding machine, and the housing 11 is obtained by removing the mold only after the resin material has cooled and formed. If this molding method is used, there will be a regular or irregular demarcation line between the first body 110 and the second body 111. In an embodiment, the demarcation line will be moire-like. This molding method can also meet the visualization need for the connection part 123 of the connecting terminal 10 and also has a higher production efficiency.

As shown in FIG. 1, after the housing 11 is formed via an injection molding process, the first body 110 is located in an upper region of the housing 11, and the second body 111 is located in a lower region of the housing 11. The first body 110 and the second body 111 are disposed opposite each other. Thus, the user looking at the side of the first body 110 would be able to see the conductor member 12 inside. In this embodiment, as described above, the housing 11 of the connecting terminal 10 is made of the first resin material and the second resin material. The first resin material has certain transparency that meets the visualization needs for the connection part 123 of the connecting terminal 10. The second resin material has high toughness. For example, the second resin material may be a high toughness and an opaque material, which can prevent the housing 11 of the connecting terminal 10 from cracking during use.

A connecting terminal 20 according to another embodiment is shown in FIGS. 4-6.

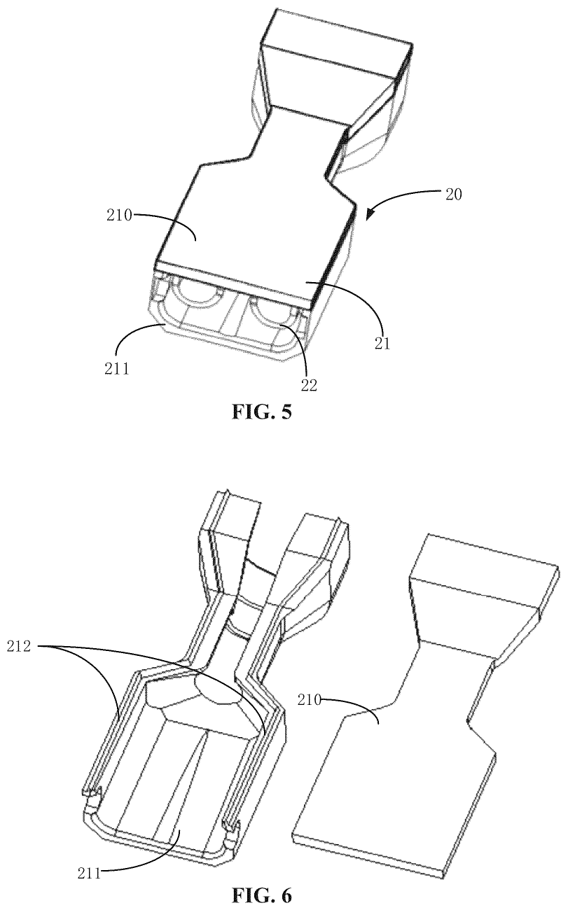

As shown in FIGS. 4-5, the connecting terminal 20 comprises a housing 21 and a conductor member 22. In an embodiment, the conductor member 22 is made of a metal material. The housing 21 at least partially encloses the conductor member 22. The housing 21 includes a first body 210 and a second body 211. The first body 210 and the second body 211 are integrally formed. The first body 210 is made of the first resin material and the second body 211 is made of the second resin material. The first resin material is different from the second resin material. The first resin material is a transparent material or a translucent material so that the user can view at least a portion of the conductor member 22 through the first body 210. The first body 210, made of the first resin material that is made of the transparent material or the translucent material, is shown in FIG. 4. As shown in FIG. 4, the first body 210 is adjacent to a connection part 223 of the conductor member 22 to allow the user to be able to view, through the first body 210, a connection condition of the conductor member 22.

A way of forming the housing 21 of the connecting terminal 20 using secondary injection molding is now described.

For example, the first resin material and the second resin material may form the housing 21 by secondary injection molding. The second resin material may be injected into the first set of molds and cooled to be molded as the second body 211 as shown in FIG. 6. The internal structure of the first set of molds may make the second body 211 as molded have a convex rib 212. Subsequently, the second body 211 may be placed into the second set of molds in which the first resin material is then injected. The first body 210 and the second body 211 may be fused together as a single body after the heat fusion stage. Finally, the housing 21 as molded may be obtained by cooling and demolding. Due to the presence of the convex rib 212 in the second body 211 before the heat fusion, a concave-convex structured bond part would be formed between the first body 210 and the second body 211 after the heat fusion, which increases the heat fusion bonding area between the first body 210 and the second body 211, thus improving the bonding force between the first resin material and the second resin material. Thus, the first body 210 and the second body 211 are bonded to each other at the convex rib 212.

After the injection molding process, the first body 210 is located in an upper region of the housing 21, and the second body 211 is located in a lower region of the housing 11 as shown in FIG. 4. The first body 210 and the second body 211 are disposed opposite to each other. The user looking at the side of the first body 210 would be able to see the conductor member 22 inside.

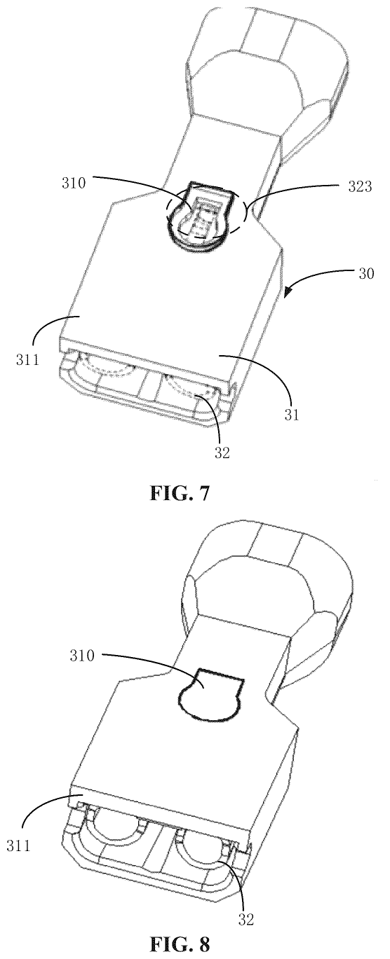

A connecting terminal 30 according to another embodiment is shown in FIGS. 7-9.

As shown in FIGS. 7-9, the connecting terminal 30 comprises a housing 31 and a conductor member 32. In an embodiment, the conductor member 32 is made of a metal material. The housing 31 includes a first body 310 and a second body 311. The first body 310 and the second body 311 are integrally formed. The first body 310 is made of the first resin material and the second body 311 is made of the second resin material. The first resin material is different from the second resin material. The first resin material is a transparent material or translucent material so that the user can view at least a portion of the conductor member 32 through the first body 310.

The first body 310, made of the first resin material that is made of the transparent material or the translucent material, is shown in FIG. 7. As shown in FIG. 7, the first body 310 is adjacent to a connection part 323 of the conductor member 32 to allow the user to be able to view, through the first body 310, a connection condition of the conductor member 32.

A way of forming the housing 31 of the connecting terminal 30 using secondary injection molding is now described.

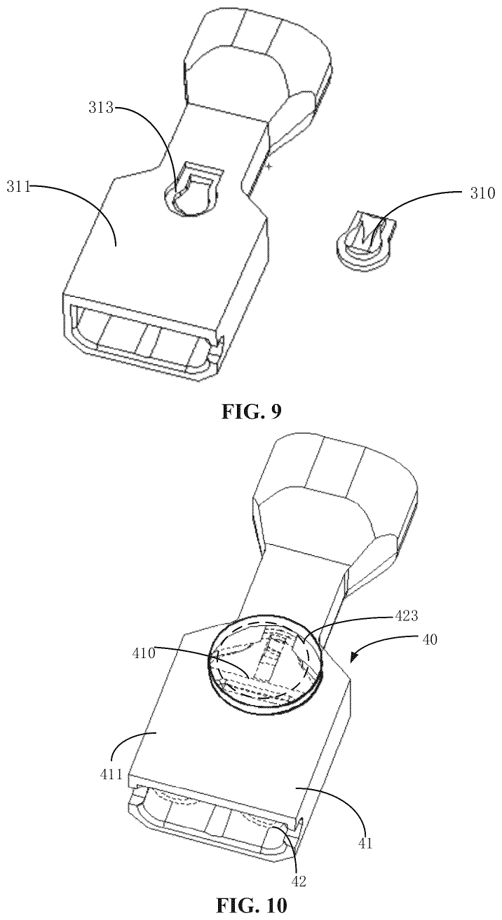

For example, the first resin material and the second resin material may form the housing 31 by secondary injection molding. The second resin material may be injected into the first set of molds and cooled to be molded as the second body 311 as shown in FIG. 9. The internal structure of the first set of molds may make the second body 311 as molded have an aperture 313 that is stepped. Subsequently, the second body 311 may be placed into the second set of molds in which the first resin material is then injected. The first body 310 and the second body 311 may be fused together as a single body after a heat fusion stage. Finally, the housing 31 as molded may be obtained by cooling and demolding. Due to the presence of the aperture 313 in the second body 311 before the heat fusion, a step-structured bond part would be formed between the first body 310 and the second body 311 after the heat fusion, which increases the heat fusion bonding area between the first body 310 and the second body 311, thus improving the bonding force between the first resin material and the second resin material. Thus, the first body 310 and the second body 311 are bonded to each other at the aperture 313.

The second body 311 has the aperture 313 provided on the second body 311 as shown in FIGS. 7 and 9. After the injection molding process, a shape of the first body 310 is adapted to correspond to a shape of the aperture 313 of the second body 311. The second body 311 surrounds the first body 310. The user looking at the side of the first body 310 would be able to see the connection condition of the conductor member 32 inside.

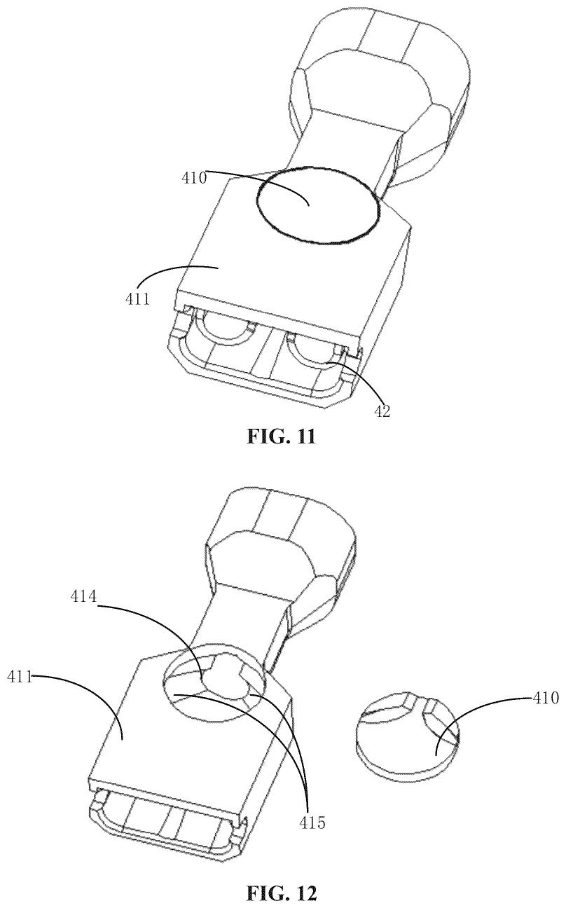

A connecting terminal 40 according to another embodiment is shown in FIGS. 10-12.

As shown in FIGS. 10-12, the connecting terminal 40 comprises a housing 41 and a conductor member 42. In an embodiment, the conductor member 42 is made of a metal material. The housing 41 includes a first body 410 and a second body 411. The first body 410 and the second body 411 are integrally formed. The first body 410 is made of the first resin material and the second body 411 is made of the second resin material. The first resin material is different from the second resin material. The first resin material is a transparent material or a translucent material so that the user can view at least a portion of the metal member through the first body 410. The first body 410, made of the first resin material that is the transparent material or the translucent material, is shown in FIG. 10. As shown in FIG. 10, the first body 410 is adjacent to a connection part 423 of the conductor member 42 to allow the user to be able to view, through the first body 410, a connection condition of the conductor member 42.

A way of forming the housing 41 of the connecting terminal 40 using secondary injection molding is now described.

For example, the first resin material and the second resin material may form the housing 41 by secondary injection molding. The second resin material may be injected into the first set of molds and cooled to be molded into the second body 411 as shown in FIG. 12. The internal structure of the first set of molds may make the second body 411 as molded have an aperture 414. The aperture 414 includes multiple groove structures 415 provided on the aperture 414. Subsequently, the second body 411 may be placed into the second set of molds in which the first resin material is then injected. The first body 410 and the second body 411 may be fused together as a single body after a heat fusion stage. Finally, the housing 41 as molded may be obtained by cooling and demolding. Due to the presence of the multiple groove structures 415 in the second body 411 before the heat fusion, a concave-convex structured bond part would be formed between the first body 410 and the second body 411 after the heat fusion, which increases the heat fusion bonding area between the first body 410 and the second body 411, thus improving the bonding force between the first resin material and the second resin material. Thus, the first body 410 and the second body 411 are bonded to each other at the aperture 414.

The second body 411 has the aperture 414 provided on the second body 411 as shown in FIGS. 10 and 12. After the injection molding process, a shape of the first body 410 is adapted to correspond to a shape of the aperture 414 of the second body 411. The second body 411 surrounds the first body 410. The user looking at the side of the first body 410 would be able to see the connection condition of the conductor member 42 inside.

As can be seen from the multiple examples described above, the position occupied by the first body 110,210,310,410 in the housing 11,21,31,41 and the shape of the first body 110,210,310,410 may be varied, as long as it meets the visualization needs for the connection part 123,223,323,423 of the connecting terminal 10,20,30,40. The connection part 123,223,323,423 of the connecting terminal 10,20,30,40 is not limited to connecting the connecting terminal 10,20,30,40 and the cable, but may also connect the connecting terminal 10,20,30,40 and a mating terminal. In addition, the conductor member 12,22,32,42 of the connecting terminal 10,20,30,40 is not limited to the conductor member 12,22,32,42 provided in the above examples, but may also be other types of conductor members.

The embodiments as described above are merely exemplary embodiments of the present disclosure and are not intended to limit the embodiments of the present disclosure, which may be subject to various modifications and variations for those skilled in the art. Any modifications, equivalent substitutions, improvements, and the like made within the spirit and principles of the embodiments of the present disclosure shall be included in the scope of protection of the embodiments of the present disclosure.

While some embodiments of the present disclosure have been described with reference to a number of specific embodiments, it should be understood that the embodiments of the present disclosure are not limited to the specific embodiments disclosed. Embodiments of the present disclosure are intended to cover various modifications and equivalent arrangements included within the spirit and scope of the appended claims. The scope of the appended claims conforms to the broadest interpretation and thus encompasses all such modifications and equivalent structures and features.

Compared with the prior art housing made of the single resin material, the housing 11,21,31,41 of the connecting terminal 10,20,30,40 provided in the present disclosure is more flexible in material selection and reduces the product cost while still meeting the use requirements of the terminal 10,20,30,40. Thus, as compared to housings made of a single resin material, the housing 11,21,31,41 gives manufacturers more flexibility in what materials they can choose to use to manufacture the housing 11,21,31,41 out of while also reducing the manufacturing cost of the housing 11,21,31,41. The housing 11,21,31,41 can also improve other performances (e.g., flame retardance) of the terminal 10,20,30,40. For example, the flame retardance of the prior art housing made of a single nylon material is typically a UL94-V2 rating, whereas the flame retardance of an embodiment of the housing 11,21,31,41 made of multiple nylon materials provided in the present disclosure may reach a UL94-V0 rating, with no ignition at a burning wire test temperature of 750° C.

What is claimed is:

1. A connecting terminal, comprising:
a conductor member, the conductor member is at least partially enclosed by a housing; and
the housing includes a first body made of a first resin material and a second body made of a second resin material, the first resin material is different from the second resin material, and the first body and the second body are integrated.

2. The connecting terminal of claim 1, wherein the first resin material is a transparent material, the transparent material enables a user to view at least a portion of the conductor member through the first body.

3. The connecting terminal of claim 2, wherein the first body is adjacent to a connection part of the conductor member to enable the user to view a connection condition of the conductor member through the first body.

4. The connecting terminal of claim 1, wherein the second resin material has a higher toughness than the first resin material.

5. The connecting terminal of claim 4, wherein the first resin material is a first polycarbonate material, and the second resin material is a second polycarbonate material.

6. The connecting terminal of claim 4, wherein the first resin material is a first polyamide material, and the second resin material is a second polyamide material.

7. The connecting terminal of claim 5, wherein the housing further comprises a third body, the third body is integrated with the first body and the second body.

8. The connecting terminal of claim 7, wherein the third body is made of a third polycarbonate material, the third polycarbonate material is a different color than the second polycarbonate material.

9. The connecting terminal according to claim 7, wherein the third body is made of a third polyamide material, the third polyamide material is a different color than the second polyamide material.

10. The connecting terminal of claim 1, wherein the first body has a convex rib, the first body and the second body are bonded to each other at the convex rib.

11. The connecting terminal of claim 1, wherein the second body has an aperture, the first body and the second body are bonded to each other at the aperture.

12. The connecting terminal of claim 1, wherein the first body is located in an upper region of the housing, the second body is located in a lower region of the housing, and the first body is disposed opposite the second body.

13. The connecting terminal according to claim 11, wherein the aperture is provided on the second body, a shape of the first body corresponds to a shape of the aperture.

14. The connecting terminal according to claim 1, wherein the first resin material is a translucent material and the second resin material is an opaque material.

15. A housing for a connecting terminal, comprising:
a first body made of a first resin material, the first resin material is a transparent material; and
a second body made of a second resin material, the second resin material is an opaque material, the first body and the second body are integrated.

16. The housing of claim 15, wherein the second resin material has a higher toughness than the first resin material.

17. The housing of claim 15, wherein the first body has a convex rib, the first body and the second body are bonded to each other at the convex rib.

18. The housing of claim 15, wherein the second body has an aperture, the first body and the second body are bonded to each other at the aperture.

19. The housing of claim 15, wherein the first body is located in an upper region of the housing, the second body is located in a lower region of the housing, and the first body is disposed opposite the second body.

20. The housing of claim 18, wherein the aperture is provided on the second body, a shape of the first body corresponds to a shape of the aperture.
